(19) United States
(12) Patent Application Publication
(10) Pub. No.: US 2025/0189877 A1
(43) Pub. Date: Jun. 12, 2025

(54) ILLUMINATOR AND PROJECTOR

(71) Applicant: SEIKO EPSON CORPORATION, Tokyo (JP)

(72) Inventor: Shigekazu AOKI, MATSUMOTO-SHI (JP)

(21) Appl. No.: 18/978,220

(22) Filed: Dec. 12, 2024

(30) Foreign Application Priority Data
Dec. 12, 2023 (JP) 2023-208954

(51) Int. Cl. G03B 21/20

(52) U.S. Cl. CPC G03B 21/2013; G03B 21/208

(57) ABSTRACT

An illuminator according to an aspect of the present disclosure includes a first light source configured to output first light that belongs to a first wavelength band; a second light source configured to output second light that belongs to a second wavelength band; a light combining member configured to combine the first light and the second light with each other and output the combined light; a diffuser including a substrate having a diffusing surface configured to diffuse the combined light and output the diffused combined light, and a driver configured to rotate the substrate; a light collector disposed between the light combining member and the diffuser and configured to collect the combined light and direct the collected combined light toward the diffuser; a collimator element configured to parallelize the combined light output from the diffuser; a light homogenizer having a first lens array surface on which the combined light from the collimator element is incident and a second lens array surface via which the light incident from the first lens array surface exits, the first lens array surface and the second lens array surface integrated with each other; a swinging apparatus configured to swing the light homogenizer; and a superimposing lens configured to superimpose luminous fluxes output from the light homogenizer on one another.

The present application is based on, and claims priority from JP Application Serial Number 2023-208954, filed Dec. 12, 2023, the disclosure of which is hereby incorporated by reference herein in its entirety.

### BACKGROUND

### 1. Technical Field

The present disclosure relates to an illuminator and a projector.

### 2. Related Art

To enhance the performance of projectors, there has been a proposed projector including an illuminator using a laser light source, which is a wide-color-gamut, high-efficiency light source. JP-A-2019-078906 discloses an illuminator including a blue light source array, a red light source array, a green light source array, a light combining system, a light collecting lens, a diffuser plate, and multi-lens arrays.

JP-A-2019-078906 is an example of the related art.

In the illuminator described above, since multiple lenses are regularly arranged in each of the multi-lens arrays, luminous fluxes widened by the lenses or diffracted luminous fluxes each generated by adjacent lenses may be superimposed on each other and interfere with each other. There is therefore a problem of illuminance unevenness in an image projected by the projector described above due to the optical interference.

### SUMMARY

To solve the problem described above, according to one aspect of the present disclosure, there is provided an illuminator including: a first light source configured to output first light that belongs to a first wavelength band; a second light source configured to output second light that belongs to a second wavelength band different from the first wavelength band; a light combining member configured to combine the first light and the second light with each other and output the combined light; a light homogenizer having a first lens array surface on which the combined light is incident and a second lens array surface via which light traveling via the first lens array surface exits, the first lens array surface and the second lens array surface integrated with each other; a swinging apparatus configured to swing the light homogenizer; and a superimposing lens configured to superimpose luminous fluxes output from the light homogenizer on one another.

According to another aspect of the present disclosure, there is provided a projector including: the illuminator according to the aspect described above; a light modulator configured to modulate light output from the illuminator; and a projection optical apparatus configured to project the light modulated by the light modulator.

### BRIEF DESCRIPTION OF THE DRAWINGS

FIG. 1 is a schematic configuration diagram showing a projector.

FIG. 2 shows a schematic configuration of an illuminator.

FIG. 3 shows the configuration of a light homogenizer.

FIG. 4 shows an example of the configuration of a swinging apparatus.

FIG. 5 shows the configuration of a light homogenizer according to a first variation.

FIG. 6 shows a schematic configuration of an illuminator according to a second variation.

FIG. 7 shows a schematic configuration of an illuminator according to a third variation.

### DESCRIPTION OF EMBODIMENTS

An embodiment of the present disclosure will be described below in detail with reference to the drawings. In the drawings used in the description below, note that a characteristic portion is enlarged for convenience in some cases for clarity of the characteristic thereof, and the dimension ratio and other factors of each element are therefore not always equal to actual values.

An embodiment of the present disclosure will be described below.

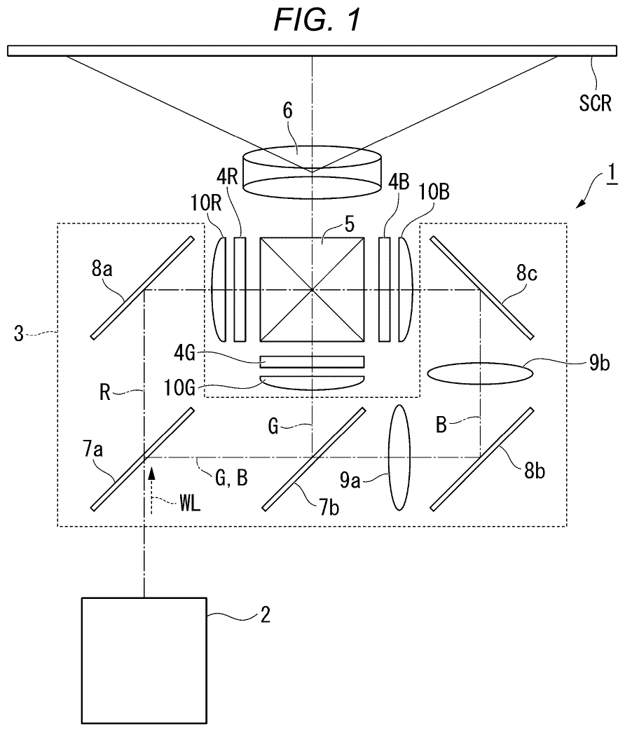

FIG. 1 is a schematic configuration diagram showing a projector according to the embodiment.

A projector 1 according to the present embodiment is a projection-type image display apparatus that displays video images on a screen SCR, as shown in FIG. 1. The projector 1 includes an illuminator 2, a color separation system 3, light modulators 4R, 4G, and 4B, a light combining system 5, and a projection optical apparatus 6.

The illuminator 2 outputs white illumination light WL toward the color separation system 3. The configuration of the illuminator 2 will be described later in detail.

The color separation system 3 separates the illumination light WL into red illumination light R, green illumination light G, and blue illumination light B. The color separation system 3 includes dichroic mirrors 7a and 7b, total reflection mirrors 8a, 8b, and 8c, a first relay lens 9a, and a second relay lens 9b. Red, green, and blue are hereinafter collectively referred to as RGB in some cases.

The dichroic mirror 7a separates the illumination light WL from the illuminator 2 into the red illumination light R and the other light (green illumination light G and blue illumination light B). The dichroic mirror 7a transmits the red illumination light R and reflects the other light. The dichroic mirror 7b reflects the green illumination light G and transmits the blue illumination light B.

The total reflection mirror 8a reflects the red illumination light R toward the light modulator 4R. The total reflection mirrors 8b and 8c guide the blue illumination light B to the light modulator 4B. The green illumination light G is reflected off the dichroic mirror 7b toward the light modulator 4G.

The first relay lens 9a and the second relay lens 9b are disposed downstream from the dichroic mirror 7b in the optical path of the blue illumination light B.

The light modulator 4R modulates the red illumination light R in accordance with image information to form red image light. The light modulator 4G modulates the green illumination light G in accordance with image information to form green image light. The light modulator 4B modulates the blue illumination light B in accordance with image information to form blue image light.

The light modulators 4R, 4G, and 4B are each, for example, a transmissive liquid crystal panel. Polarizers (not shown) are disposed at the light incident side and the light exiting side of each of the liquid crystal panels.

Field lenses 10R, 10G, and 10B are disposed at the light incident side of the light modulators 4R, 4G, and 4B, respectively.

The red image light from the light modulator 4R, the green image light from the light modulator 4G, and the blue image light from the light modulator 4B enter the light combining system 5. The light combining system 5 combines the three types of image light with one another and outputs the combined image light toward the projection optical apparatus 6. The light combining system 5 is, for example, a cross dichroic prism.

The projection optical apparatus 6 is configured with a projection lens group, enlarges the combined image light from the light combining system 5, and projects the enlarged image light toward the screen SCR. Enlarged color video images are thus displayed on the screen SCR.

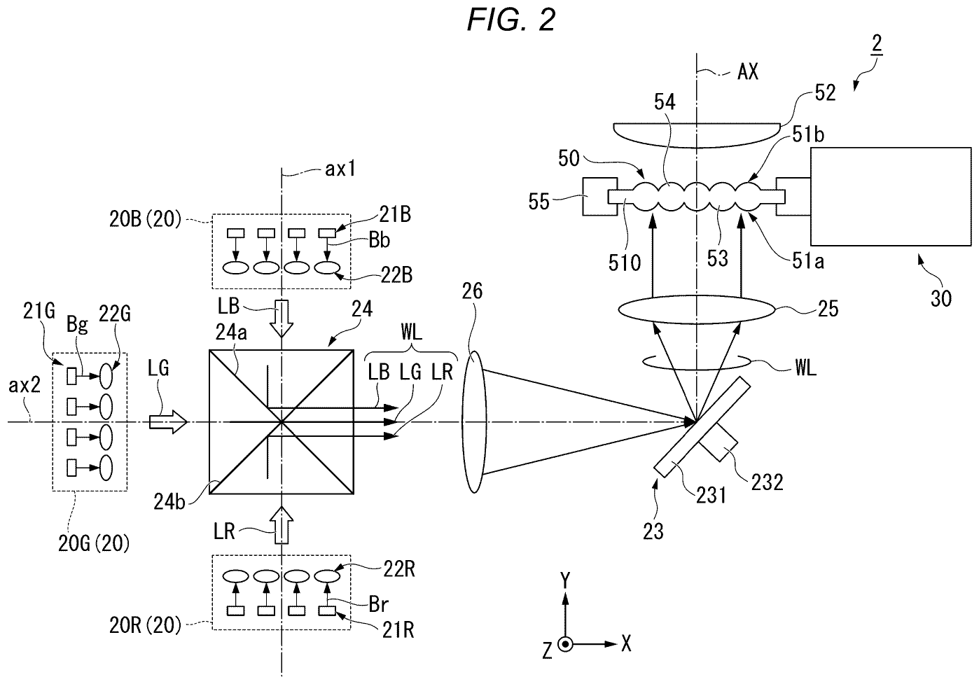

The illuminator 2 according to the embodiment of the present disclosure will subsequently be described. FIG. 2 shows a schematic configuration of the illuminator 2.

The illuminator 2 includes a light source apparatus 20, a light collector 26, a rotary diffuser 23, a collimator element 25, a light homogenizer 50, a superimposing lens 52, and a swinging apparatus 30, as shown in FIG. 2.

The light source apparatus 20 includes a red light source (first light source) 20R, a green light source (second light source) 20G, a blue light source (third light source) 20B, and a light combining member 24.

In the present embodiment, the red light source 20R, the light combining member 24, and the blue light source 20B are provided in an optical axis ax1 of the red light source 20R. The green light source 20G, the light combining member 24, the light collector 26, and the rotary diffuser 23 are provided in an optical axis ax2 of the green light source 20G. The rotary diffuser 23, the collimator element 25, the light homogenizer 50, and the superimposing lens 52 are provided in an illumination optical axis AX of the illuminator 2. The optical axis of the blue light source 20B coincides with the optical axis ax1 of the red light source 20R, and the optical axis ax2 of the green light source 20G coincides with the illumination optical axis AX. The optical axis ax1 and the optical axis ax2 are perpendicular to each other, and the optical axis ax1 and the illumination optical axis AX are parallel to each other.

In the following description of the shapes and arrangement of the constituent members of the illuminator 2, an XYZ coordinate system is used in some cases. The present specification will be described under the following definition: an X direction is the direction in which green light LG is output from the green light source 20G and which is along the optical axis ax2; a Y direction is the direction along the illumination optical axis AX of the illuminator 2; and a Z direction is the direction perpendicular to the X and Y directions.

The red light source 20R includes multiple red semiconductor lasers 21R and multiple collimator lenses 22R. The green light source 20G includes multiple green semiconductor lasers 21G and multiple collimator lenses 22G. The blue light source 20B includes multiple blue semiconductor lasers 21B and multiple collimator lenses 22B.

That is, the light sources 20R, 20G, and 20B are each a laser light source.

The multiple red semiconductor lasers 21R are arranged in an array in a plane perpendicular to the optical axis ax1. The red semiconductor lasers 21R each output a red beam Br, which belongs to a first wavelength band ranging, for example, from 585 nm to 720 nm. The multiple collimator lenses 22R are disposed in correspondence with the multiple red semiconductor lasers 21R, and convert the red beams Br output from the corresponding lasers each into parallelized light.

Based on the configuration described above, the red light source 20R outputs red light LR containing the multiple red beams Br each being a parallelized luminous flux toward the light combining member 24.

The multiple green semiconductor lasers 21G are arranged in an array in a plane perpendicular to the illumination optical axis AX. The green semiconductor lasers 21G each output a green beam Bg, which belongs to a second wavelength band different from the first wavelength band and ranging, for example, from 495 nm to 585 nm. The multiple collimator lenses 22G are disposed in correspondence with the multiple green semiconductor lasers 21G, and convert the green beams Bg output from the corresponding lasers each into parallelized light.

Based on the configuration described above, the green light source 20G outputs the green light LG containing the multiple green beams Bg each being a parallelized luminous flux toward the light combining member 24.

The multiple blue semiconductor lasers 21B are arranged in an array in a plane perpendicular to the optical axis ax1. The blue semiconductor lasers 21B each output a blue beam Bb, which belongs to a third wavelength band different from the first and second wavelength bands and ranging, for example, from 380 nm to 495 nm. The multiple collimator lenses 22B are disposed in correspondence with the multiple blue semiconductor lasers 21B, and convert the blue beams Bb output from the corresponding lasers each into parallelized light.

Based on the configuration described above, the blue light source 20B outputs the blue light LB containing the multiple blue beams Bb each being a parallelized luminous flux toward the light combining member 24.

The light combining member 24 outputs the white illumination light WL in one direction, which is the combination of the three types of color light RGB (red light LR, green light LG, and blue light LB) output from the light source apparatus 20, and causes the output white illumination light WL to enter the light collector 26. The light collector 26 collects the illumination light WL at a predetermined position.

The light combining member 24 is configured with a cross dichroic prism. The cross dichroic prism includes a first dichroic mirror 24a and a second dichroic mirror 24b. The first dichroic mirror 24a and the second dichroic mirror 24b are disposed so as to intersect with the optical axes ax1 and ax2 at 45°. The first dichroic mirror 24a and the second dichroic mirror 24b intersect with each other at an angle of 90°.

The first dichroic mirror 24a is optically characterized by reflecting the blue light LB and transmitting the green light LG and the red light LR. The second dichroic mirror 24b is optically characterized by reflecting the red light LR and transmitting the blue light LB and the green light LG.

The light collector 26 collects the illumination light WL and causes the collected illumination light WL to be incident on the rotary diffuser 23. The rotary diffuser 23 diffuses the illumination light WL to homogenize the illuminance distribution of the illumination light WL. The rotary diffuser 23 includes a diffuser plate 231 rotatable around a predetermined axis of rotation, and a driver 232 configured with a motor. The diffuser plate 231 is produced, for example, by forming an irregular structure at a surface of a circular plate made of metal such as aluminum, for example, in an etching or blasting process. The rotary diffuser 23 is disposed so as to intersect the optical axis ax2 and the illumination optical axis AX at 45°.

The collimator element 25 parallelizes the illumination light WL output from the rotary diffuser 23 and outputs the parallelized illumination light WL toward the light homogenizer 50. In the present embodiment, the collimator element 25 is configured with a single convex lens. Note that the collimator element 25 may be configured with multiple lenses.

The light homogenizer 50, along with the superimposing lens 52, homogenizes illuminance distribution of the illumination light WL output from the collimator element 25 in an image generation region of each of the light modulators 4R, 4G, and 4B.

The light homogenizer 50 in the present embodiment includes a double-sided multi-lens array that is a unit of a first lens array surface 51a and a second lens array surface 51b integrated with each other. That is, the light homogenizer 50 in the present embodiment is configured with a single optical member that is a unit of the first lens array surface 51a and the second lens array surface 51b integrated with each other.

The intervals between the lenses of the multi-lens array, which constitutes the light homogenizer 50 in the present embodiment, are preferably set at a value, for example, greater than or equal to 0.1 mm but smaller than or equal to 1 mm. The light homogenizer 50 is thus configured with a small-interval microlens array unit, and the light homogenizing performance of the light homogenizer 50 can be enhanced by increasing the number of light source images superimposed on one another on an illumination receiving region.

The first lens array surface 51a is a surface on which the illumination light WL output from the collimator element 25 is incident. The first lens array surface 51a includes multiple first lenslets 53, which divide the illumination light WL into multiple sub-luminous fluxes. The multiple first lenslets 53 are arranged in a matrix in a plane perpendicular to the illumination optical axis AX.

The second lens array surface 51b is a surface via which the multiple sub-luminous fluxes, into which the illumination light WL is divided via the first lens array surface 51a, exit. The second lens array surface 51b includes multiple second lenslets 54 corresponding to the first lenslets 53 at the first lens array surface 51a. The second lens array surface 51b along with the downstream superimposing lens 52 forms images of the first lenslets 53 at the first lens array surface 51a in the image generation region of each of the light modulators 4R, 4G, and 4B or in the vicinity of the image generation region. The multiple second lenslets 54 are arranged in a matrix in a plane perpendicular to the illumination optical axis AX.

The superimposing lens 52 collects the multiple sub-luminous fluxes output from the light homogenizer 50 and superimposes the collected sub-luminous fluxes on one another in the image generation region of each of the light modulators 4R, 4G, and 4B or in the vicinity of the image generation region.

The light homogenizer 50 is housed in a holder 55. The holder 55 is a frame-shaped, rubber-like member that surrounds an outer circumferential section 510 of the light homogenizer 50. The swinging apparatus 30 is disposed in contact with the holder 55, and swings the light homogenizer 50 via the holder 55. The holder 55 in the present embodiment holds the light homogenizer 50 with the rotation of the light homogenizer 50 around the Z-axis or the X-axis restricted.

The swinging apparatus 30 swings the first lens array surface 51a and the second lens array surface 51b as a unit along a direction perpendicular to the optical axis of the light homogenizer 50. The situation in which the first lens array surface 51a and the second lens array surface 51b swing as a unit means that the positional relationship between the first lens array surface 51a and the second lens array surface 51b does not change even when the light homogenizer 50 is swung by the swinging apparatus 30.

More specifically, the swinging apparatus 30 swings the first lens array surface 51a and the second lens array surface 51b as a unit along the X direction (first direction) perpendicular to the optical axis of the light homogenizer 50 and the Z direction (second direction) perpendicular to the optical axis and the X direction. The light homogenizer 50 swings with the rotation thereof around the Z-axis or the X-axis restricted by the holder 55.

In the projector 1 according to the present embodiment, the first lens array surface 51a of the light homogenizer 50 is optically conjugate with the image generation region, which generates an image in each of the light modulators 4R, 4G, and 4B. The first lenslets 53 at the first lens array surface 51a each therefore have a rectangular shape substantially similar to the shape of the image generation region of each of the light modulators 4R, 4G, and 4B.

Furthermore, the screen surface on which the image light generated in the image generation region of each of the light modulators 4R, 4G, and 4B is projected is optically conjugate with the image generation region of each of the light modulators 4R, 4G, and 4B. That is, the first lens array surface 51a, which is conjugate with the image generation regions, is indirectly conjugate with the screen surface.

In the projector 1 according to the present embodiment, swinging the first lens array surface 51a of the light homogenizer 50, which is conjugate with the screen surface, can cause viewers to unlikely visually recognize illuminance unevenness in a projected image, as will be described later.

The frequency of the swinging motion generated by the swinging apparatus 30 is preferably higher than or equal to 60 Hz but lower than or equal to 500 Hz.

The reason for this is that a flicker unfavorably occurs in a projected image when the frequency is lower than 60 Hz. When the frequency is higher than 500 Hz, it is necessary to further increase the robustness of the swinging apparatus 30 itself and an illuminator body that houses the swinging apparatus 30, contributing to an increase in cost.

Therefore, in the projector 1 according to the present embodiment, in which the frequency of the swinging motion generated by the swinging apparatus 30 is set at a value higher than or equal to 60 Hz but lower than or equal to 500 Hz, the configuration that reduces the illuminance unevenness can be realized at low cost with the flicker suppressed.

The amplitude of the swinging motion of the light homogenizer 50 generated by the swinging apparatus 30 is set, for example, at 150 μm. Note that the amplitude of the swinging motion of the light homogenizer 50 is not limited to the value described above, and is adjusted as appropriate in accordance with the intervals of the lenses at the lens array surfaces and the cycle of the interference fringes that cause the illuminance unevenness.

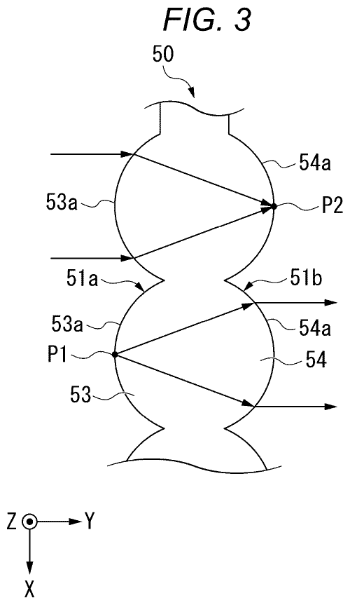

FIG. 3 shows the configuration of the light homogenizer 50.

A focal point P1 of each of the multiple second lenslets 54 at the second lens array surface 51b is located at a light incident surface 53a of the corresponding one of the multiple first lenslets 53, as shown in FIG. 3. The light incident via the light incident surface 53a of each of the first lenslets 53 therefore exits as parallelized light from the corresponding second lenslet 54.

A focal point P2 of each of the multiple first lenslets 53 at the first lens array surface 51a is located at a light exiting surface 54a of the corresponding one of the multiple second lenslets 54. The sub-luminous fluxes into which the illumination light WL is divided by the first lenslets 53 are therefore collected on the light exiting surfaces 54a of the second lenslets 54, so that the second lenslets 54 can efficiently capture the light from the first lenslets 53 and output the captured light. Optical loss in the light homogenizer 50 can thus be reduced.

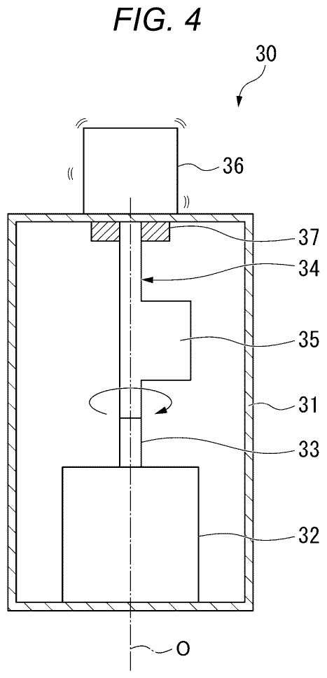

FIG. 4 shows an example of the configuration of the swinging apparatus 30.

The swinging apparatus 30 includes an enclosure body 31 including a contact section 36, which is in contact with the light homogenizer 50, a motor 32 including a shaft 33, which rotates around an axis of rotation O, a rotary member 34 attached to the shaft 33 of the motor 32, and a bearing 37, which rotatably supports the rotary member 34, as shown in FIG. 4. The axis of rotation O is an imaginary axis passing through the center of the shaft 33.

The enclosure body 31 houses the motor 32, the rotary member 34, and the bearing 37 therein. One end of the rotary member 34 in the direction along the axis of rotation O is linked to the shaft 33, the other end of the rotary member 34 in the direction along the axis of rotation O is held by the bearing 37, and a weight 35 eccentric with respect to the axis of rotation O is provided at a central portion of the rotary member 34. The state in which the weight 35 is eccentric with respect to the axis of rotation O means a state in which the center of gravity of the weight 35 is shifted in the direction perpendicular to the axis of rotation O.

In the swinging apparatus 30, when the shaft 33 of the motor 32 rotates, the rotary member 34 rotates along with the shaft 33. In this operation, since the center of gravity of the weight 35 rotates while shifted from the axis of rotation O, the weight 35 shakes and therefore vibrates the motor 32 itself. The vibration of the motor 32 is transmitted to the enclosure body 31, and swings the light homogenizer 50 via the contact section 36.

The swinging apparatus 30 in the present embodiment, which has a simple configuration in which the rotary member 34, which rotates along with the shaft 33 of the motor 32, is provided with the weight 35 eccentric with respect to the axis of rotation O, can realize a configuration in which the light homogenizer 50 is swung at low cost without an increase in the size of the configuration of the swinging apparatus 30.

As described above, the Illuminator 2 according to the present embodiment includes the red light source 20R, which outputs the red light LR, the green light source 20G, which outputs the green light LG, the blue light source 20B, which outputs the blue light LB, the light combining member 24, which combines the red light LR, the green light LG, and the blue light LB with one another and outputs the illumination light WL, the rotary diffuser 23, which diffuses the illumination light WL, the light collector 26, which is disposed between the light combining member 24 and the rotary diffuser 23, collects the illumination light WL, and directs the collected illumination light WL toward the rotary diffuser 23, the collimator element 25, which parallelizes the illumination light WL output from the rotary diffuser 23, the light homogenizer 50, which has the first lens array surface 51a, on which the illumination light WL output from the collimator element 25 is incident, and the second lens array surface 51b, via which the light having traveling via the first lens array surface 51a exits, the first lens array surface 51a and the second lens array surface 51b integrated with each other, the swinging apparatus 30, which swings the light homogenizer 50, and the superimposing lens 52, which superimposes the sub-luminous fluxes output from the light homogenizer 50 on one another.

The first lens array surface 51a of the light homogenizer 50 has the structure in which the multiple first lenslets 53 are regularly arranged as described above. The sub-luminous fluxes into which the illumination light WL is divided by the multiple first lenslets 53 at the first lens array surface 51a or the diffracted luminous fluxes generated at the ridge between adjacent ones of the first lenslets 53 may therefore unfavorably interfere with each other.

In the present embodiment, since the three types of color light LR, LG, and LB contained in the illumination light WL are each coherent light, light interference is likely to occur. The sub-luminous fluxes output from the first lens array surface 51a of the light homogenizer 50 may therefore cause streaky or striped illuminance unevenness due to the optical interference in the image generation regions of the light modulators 4R, 4G, and 4B and on the screen surface, which are optically conjugate with each other. The illuminance unevenness may contribute to deterioration of the visibility of a projected image. The shapes of and intervals between the streaks or stripes of the illuminance unevenness caused by the optical interference vary depending, for example, on the shape of the first lenslets 53 and the intervals between the ridges between the first lenslets 53.

In contrast, the illuminator 2 according to the present embodiment, in which the first lens array surface 51a, which is a surface conjugate with the screen SCR, is swung by the swinging apparatus 30, can provide the same advantages as those achieved when the screen SCR on which an image is projected is swung in an apparent manner. That is, the illuminance unevenness in a projected image generated by the three types of color light LR, LG, and LB is temporally changed on the screen SCR, as in the case where the screen SCR is swung. Viewers of the projector 1 thus visually recognize time-averaged streaks or stripes, and are therefore unlikely to visually recognize the illuminance unevenness.

Furthermore, in the illuminator 2 according to the present embodiment, since the three types of color light LR, LG, and LB contained in the illumination light WL are each coherent light, speckles may be unfavorably generated in a projected image. In contrast, in the illuminator 2 according to the present embodiment, the swinging apparatus 30 can swing the first lens array surface 51a, which is a surface conjugate with the screen SCR, to also reduce speckle noise in a projected image.

Moreover, in the illuminator 2 according to the present embodiment, the focal point P1 of each of the second lenslets 54 is located at the light incident surface 53a of the corresponding first lenslet 53 as described above, parallelized light can be output from each of the second lenslets 54 even when the light homogenizer 50 is swung. The configuration described above can suppress a change in the angle of incidence of the light output from the second lens array surface 51b of the light homogenizer 50 with respect to the superimposing lens 52.

In the present embodiment, when the light homogenizer 50 is swung, rotation of the light homogenizer 50 around the Z-axis or the Y-axis is restricted, so that the light output as parallelized light from the second lens array surface 51b is caused to be incident on the superimposing lens 52 at a predetermined angle.

As described above, in the illuminator 2 according to the present embodiment, even when the light homogenizer 50 is swung, the angle of incidence of the light incident from the light homogenizer 50 on the superimposing lens 52 does not change, so that an illumination area illuminated with the light from the superimposing lens 52, that is, an illumination area in the image generation region of each of the light modulators 4R, 4G, and 4B, does not move.

Therefore, in the illuminator 2 according to the present embodiment, even when the light homogenizer 50 is swung, the position of the illumination area in the image generation region of each of the light modulators 4R, 4G, and 4B, which is the illumination receiving region, is not shifted.

The projector 1 according to the present embodiment including the illuminator 2, in which the first lens array surface 51a conjugate with the screen surface is swung without deterioration of the quality of a projected image, can therefore display a high-quality image in which illuminance unevenness is more unlikely to be noticed.

The illuminator 2 according to the present embodiment, which employs the reflection structure as the diffuser plate 231 of the rotary diffuser 23 as described above, can suppress disturbance of the polarization that occurs in the diffused illumination light WL. The reduction in the disturbance of the polarization of the diffused illumination light WL therefore allows the three types of color light into which the illumination light WL is separated to be efficiently incident on the image formation regions of the light modulators 4R, 4G, and 4B. The projector 1 using the illuminator 2 according to the present embodiment can therefore project a bright, high-quality image by efficiently using the illumination light WL from the illuminator 2.

Note in the illuminator 2 according to the embodiment described above that the light homogenizer 50 is configured with a single optical part including the first lens array surface 51a and the second lens array surface 51b integrated with each other, and the light homogenizer may be configured with two optical members, one optical member including a first multi-lens surface and the other optical member including a second multi-lens surface.

### First Variation

Another form of the light homogenizer will be described below as a variation. The difference between the present variation and the embodiment described above is that the first multi-lens surface and the second multi-lens surface of the light homogenizer are configured with two optical members. The configurations common to those in the embodiment described above therefore have the same reference characters and will not be described in detail.

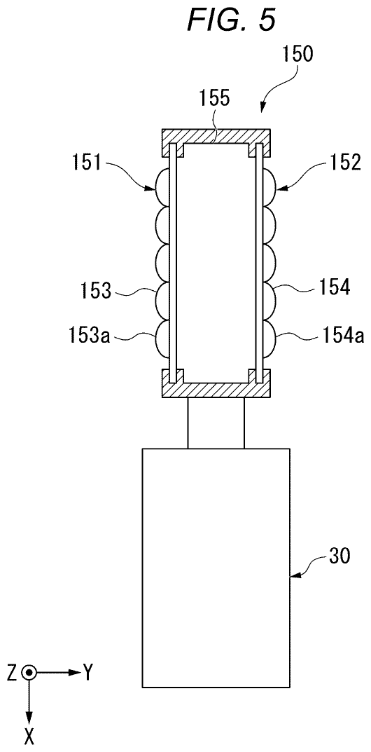

FIG. 5 shows the configuration of a light homogenizer according to the variation.

A light homogenizer 150 according to the present variation includes a first lens array (first optical member) 151, a second lens array (second optical member) 152, and a holding member 155, which holds the first lens array 151 and the second lens array 152, as shown in FIG. 5.

The first lens array 151 has a first lens array surface 153a. The first lens array surface 153a includes multiple first lenslets 153, which divide the illumination light WL into multiple sub-luminous fluxes. The second lens array 152 has a second lens array surface 154a. The second lens array surface 154a includes multiple second lenslets 154 corresponding to the first lenslets 153 at the first lens array surface 153a.

The holding member 155 holds the first lens array 151 and the second lens array 152 as a unit, and fixes the relative position of the first lens array surface 153a with respect to the second lens array surface 154a. Specifically, the holding member 155 holds the first lens array 151 and the second lens array 152 as a unit in such a way that the optical axes of the first lenslets 153 and the second lenslets 154, which correspond other respectively, coincide with each other.

Note in the light homogenizer 150 according to the present variation that the shapes of or the mutual positional relationship between the first lens array surface 153a and the second lens array surface 154a is the same as that of the first lens array surface 51a and the second lens array surface 51b of the light homogenizer 50 in the embodiment described above.

In the present variation, the swinging apparatus 30 is disposed in contact with the holding member 155, and swings the light homogenizer 150 via the holding member 155. The holding member 155 holds the light homogenizer 150 with rotation of the light homogenizer 150 around the Z-axis or the Y-axis restricted.

Also in the light homogenizer 150 according to the present variation, the first lens array surface 153a and the second lens array surface 154a can be swung as a unit by the swinging apparatus 30 along the X and Z directions perpendicular to the optical axis of the light homogenizer 150.

In the embodiment and the first variation described above, the illuminator 2 in which the light diffusively reflected off the rotary diffuser 23 enters the light homogenizer 50 has been presented by way of example, and the present disclosure is also applicable to an illuminator in which light having passed through a diffuser plate enters a light homogenizer.

### Second Variation

Another form of the illuminator will be described below as a second variation.

The present variation differs from the embodiment described above in terms peripheral configuration of the diffuser plate in the illuminator, and the other configurations are the same. The configurations common to those in the embodiment described above therefore have the same reference characters and will not be described in detail.

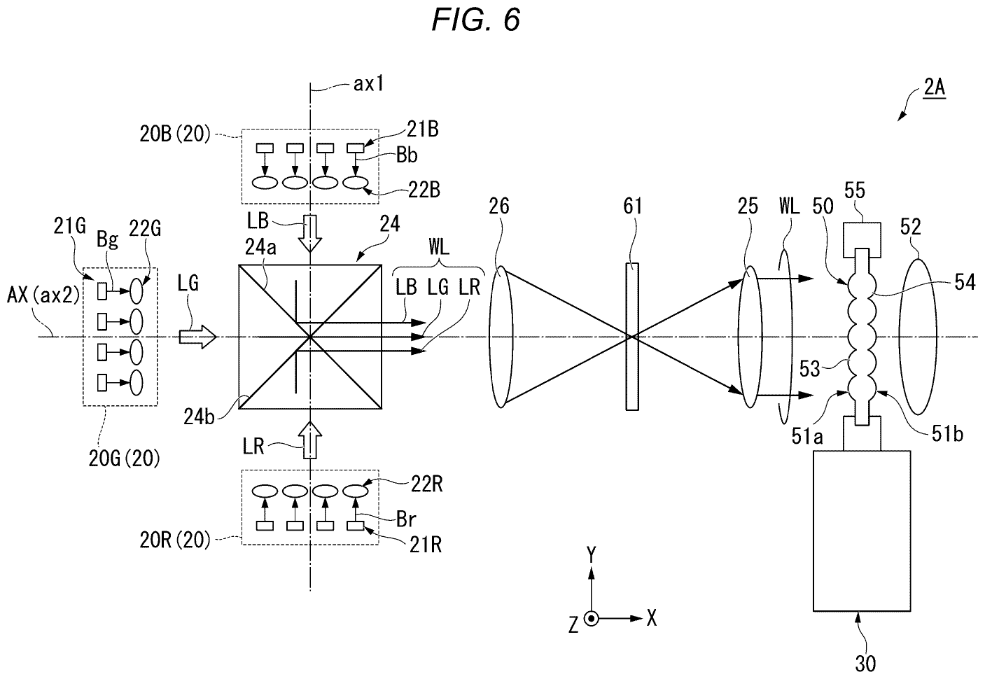

FIG. 6 shows a schematic configuration of an illuminator according to the present variation.

An illuminator 2A according to the present variation includes the light source apparatus 20, the light collector 26, a diffuser plate 61, the collimator element 25, the light homogenizer 50, the superimposing lens 52, and the swinging apparatus 30, as shown in FIG. 6.

In the present variation, the green light source 20G, the light combining member 24, the light collector 26, the diffuser plate 61, the collimator element 25, the light homogenizer 50, and the superimposing lens 52 are provided in the optical axis ax2 of the green light source 20G. In the present variation, the optical axis ax2 and the illumination optical axis AX are parallel to each other.

In the present variation, the light collector 26 collects the illumination light WL and causes the collected illumination light WL to enter the diffuser plate 61. The diffuser plate 61 is disposed at the light exiting side (+X side) of the light collector 26. The diffuser plate 61 diffuses the illumination light WL to homogenize the illuminance distribution of the illumination light WL.

The diffuser plate 61 can be a known diffuser plate, for example, a polished glass plate, a holographic diffuser, a transparent substrate having a surface subjected to blasting, or a transparent substrate containing a scattering material such as beads dispersed therein to scatter light.

Also in the illuminator 2A according to the present variation, the swinging apparatus 30 can swing the light homogenizer 50 to reduce the illuminance unevenness due to the optical interference.

### Third Variation

Another form of the illuminator will be described below as a third variation.

The present variation differs from the embodiment described above in terms of the configuration of the illuminator, and the other configurations are the same. The configurations common to those in the embodiment described above therefore have the same reference characters and will not be described in detail.

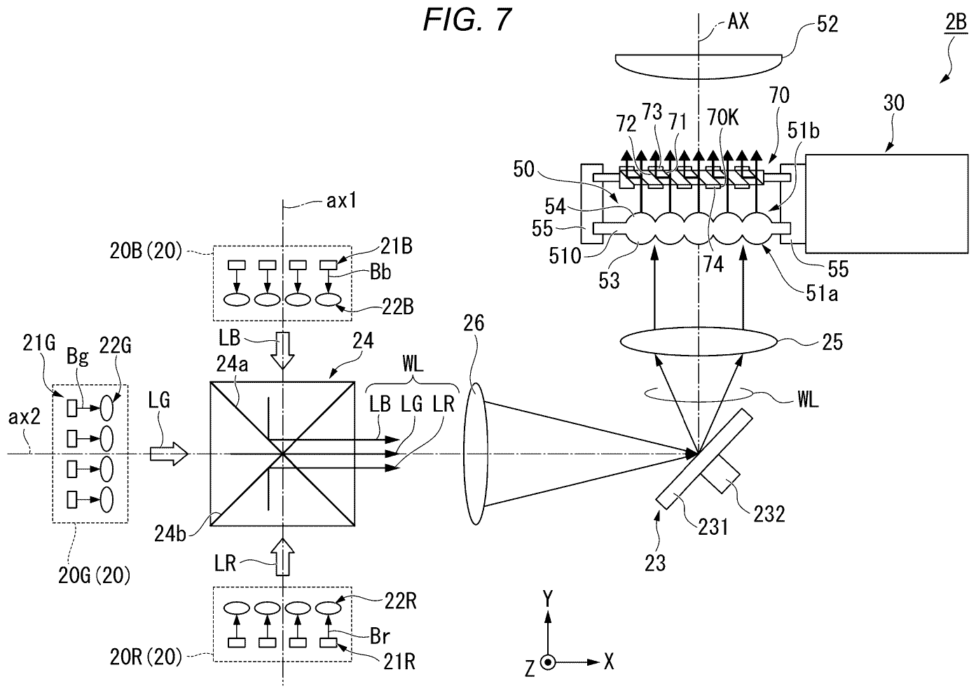

FIG. 7 shows a schematic configuration of an illuminator according to the present variation.

An illuminator 2B according to the present variation includes the light source apparatus 20, the light collector 26, the rotary diffuser 23, the collimator element 25, the light homogenizer 50, the superimposing lens 52, the swinging apparatus 30, and a polarization converter 70, as shown in FIG. 7. That is, the illuminator 2B according to the present variation differs from the illuminator 2 according to the embodiment described above in that the illuminator 2B includes the polarization converter 70 disposed between the light homogenizer 50 and the superimposing lens 52.

The polarization converter 70 is an element that aligns the polarization directions of the light output from the light homogenizer 50 with a predetermined polarization direction. The polarization converter 70 includes multiple polarization separation layers 71, multiple reflection layers 72, multiple retardation layers 73, and a light blocking film 74.

The retardation layers 73 are provided at the light exiting side of the polarization converter 70. The polarization converter 70 has multiple light incident openings 70K, through which the light output from the light homogenizer 50 passes. The light incident openings 70K are provided in correspondence with the second lenslets 54 at the second lens array surface 51b of the light homogenizer 50 in the Y direction. The light incident openings 70K are each an opening formed in the light blocking film 74 disposed at the side facing the light incident surface of the polarization converter 70.

In the present variation, the polarization converter 70 is housed in the holder 55 along with the light homogenizer 50. The swinging apparatus 30 is disposed in contact with the holder 55, and swings the polarization converter 70 along with the light homogenizer 50 via the holder 55.

In the illuminator 2B according to the present variation, the swinging apparatus 30 can swing the light homogenizer 50 to reduce the illuminance unevenness due to the optical interference. In the present variation, when the light homogenizer 50 is swung by the swinging apparatus 30, the polarization converter 70 is swung along with the light homogenizer 50, so that the positional relationship between the second lenslets 54 at the second lens array surface 51b and the light incident openings 70K of the polarization converter 70 can be fixed.

Therefore, even when the polarization converter 70 is swung along with the light homogenizer 50 by the swinging apparatus 30, the illuminator 2B according to the present variation, in which the polarization directions of the illumination light WL are aligned with one direction, allows efficient transmission of the red illumination light R, the green illumination light G, and the blue illumination light B separated from the illumination light WL through the polarizer plates disposed at the light incident side of the light modulators 4R, 4G, and 4B. The illuminator 2B according to the present variation therefore allows more efficient use of the illumination light WL.

The present variation has been described with reference to the case where the polarization converter 70 is swung along with the light homogenizer 50 by way of example, and a configuration in which the polarization converter is not swung but only the light homogenizer 50 is swung may be employed. When only the light homogenizer 50 is swung, it is preferable to use a polarization converter having a structure in which the light incident openings correspond to the respective multiple second lenslets 54 of the light homogenizer 50. Using the polarization converter having the structure described above allows the light output from the second lenslets 54 of the light homogenizer 50 to be satisfactorily captured into the polarization converter even when only the light homogenizer 50 is swung.

Note that the technical scope of the present disclosure is not limited to the embodiment described above, and a variety of changes can be made thereto without departing from the intent of the present disclosure.

The specific descriptions of the shapes, the numbers, the arrangements, the materials, and other factors of the elements of the illuminator and the projector shown in the embodiment described above are not limited to those in the embodiment described above and can be changed as appropriate.

For example, the illuminators according to the aforementioned embodiment and variations have been described by way of example with reference to the case where the light that is the combination of the three types of color light is output as the illumination light, and the present disclosure may be applied to an illuminator that outputs monochromatic illumination light. In a monochromatic illuminator, a light homogenizer on which the light output from a single light source is incident can be swung to reduce the illuminance unevenness of the illumination light output from the light homogenizer via a superimposing lens. Furthermore, such a monochromatic illuminator may be applied to a projector using only one light modulator.

The illuminators according to the aforementioned embodiment and variations have been described by way of example with reference to the case where the diffuser plate is used, and a configuration in which the light homogenizer is swung without using a diffuser plate may be employed. It is conceivable that the configuration described above, which provides no light scattering effect of the diffuser plate, makes the illuminance unevenness in the illumination receiving region more noticeable, but the present disclosure, in which the light homogenizer is swung, allows the illuminance unevenness to be unlikely to be noticed. That is, omitting the diffuser plate allows the advantages disclosed by the present application to be more remarkable.

The aforementioned embodiment and variations have been described with reference to the case where the illuminator according to the present disclosure is incorporated in a projector using liquid crystal panels, but not necessarily. The illuminator according to the present disclosure may be incorporated in a projector using digital micromirror devices as the light modulators.

The aforementioned embodiment has been described with reference to the case where the illuminator according to the present disclosure is incorporated in a projector, but not necessarily. The illuminator according to the present disclosure may be incorporated in a lighting apparatus, a headlight of an automobile, and other apparatuses.

The present disclosure will be summarized below as additional remarks.

### Additional Remark 1

An illuminator including:
a first light source configured to output first light that belongs to a first wavelength band;
a second light source configured to output second light that belongs to a second wavelength band different from the first wavelength band;
a light combining member configured to combine the first light and the second light with each other and output the combined light;
a light homogenizer having a first lens array surface on which the combined light is incident and a second lens array surface via which light traveling via the first lens array surface exits, the first lens array surface and the second lens array surface integrated with each other;
a swinging apparatus configured to swing the light homogenizer; and
a superimposing lens configured to superimpose luminous fluxes output from the light homogenizer on one another.

The thus configured illuminator, in which the first lens array surface and the second lens array surface are swung as a unit by the swinging apparatus, allows viewers to unlikely to recognize illuminance unevenness of illumination light with which an illumination receiving region in the illuminator is illuminated, as in a case where the illumination receiving region in the illuminator is swung in an apparent manner.

### Additional Remark 2

The illuminator according to the additional remark 1, wherein
the swinging apparatus swings the first and second lens array surfaces as a unit along a direction perpendicular to an optical axis of the light homogenizer.

The configuration described above, in which the swinging apparatus swings the first and second lens array surfaces as a unit in the direction perpendicular to the optical axis, allows the illuminance unevenness to be unlikely to be noticed.

### Additional Remark 3

The illuminator according to the additional remark 1 or 2, wherein
the swinging apparatus swings the first and second lens array surfaces as a unit along a first direction perpendicular to an optical axis of the light homogenizer and a second direction perpendicular to the optical axis and the first direction.

The configuration described above, in which the swinging apparatus swings the first and second lens array surfaces as a unit in the two directions, allows the illuminance unevenness to be more unlikely to be noticed.

### Additional Remark 4

The illuminator according to any one of the additional remarks 1 to 3, wherein
the first and second lens array surfaces are a single optical part formed as a unit, and
the swinging apparatus swings the optical part.

The configuration described above, which swings the light homogenizer configured with the single optical member in which the first and second lens array surfaces are formed as a unit, allows reduction in the illuminance unevenness of the combined light.

### Additional Remark 5

The illuminator according to any one of the additional remarks 1 to 4, further including
a holding member configured to hold a first optical member having the first lens array surface and a second optical member having the second lens array surface as a unit, and fix a relative position of the first lens array surface with respect to the second lens array surface,
wherein the swinging apparatus s swings the holding member.

The configuration described above, which swings the light homogenizer in which the first and second lens array surfaces are configured with separate optical members, allows reduction in the illuminance unevenness of the combined light.

### Additional Remark 6

The illuminator according to any one of the additional remarks 1 to 5, further including
a polarization converter disposed between the light homogenizer and the superimposing lens and configured to align polarization directions of the light output from the light homogenizer with a predetermined polarization direction.

The configuration described above can align the polarization directions of the combined light with the predetermined polarization direction.

### Additional Remark 7

The illuminator according to the additional remark 6, wherein
the swinging apparatus swings the polarization converter along with the light homogenizer.

The configuration described above, in which the light homogenizer and the polarization converter are swung as a unit, allows the light output from the light homogenizer to be efficiently incident on the polarization converter.

### Additional Remark 8

The illuminator according to any one of the additional remarks 1 to 7, further including:
a diffuser plate configured to diffuse the combined light incident from the light combining member; and
a collimator element configured to parallelize the combined light output from the diffuser plate.

The configuration described above, which increases the uniformity of the illuminance distribution by diffusing the combined light, can make the illuminance unevenness less noticeable. In addition, parallelizing the light diffused by the diffuser plate allows suppression of an increase in the size of the light homogenizer.

### Additional Remark 9

The illuminator according to any one of the additional remarks 1 to 8, wherein
a frequency of swinging motion generated by the swinging apparatus is higher than or equal to 60 Hz but lower than or equal to 500 Hz.

The configuration described above allows efficient reduction in the illuminance unevenness with the cost of the swinging apparatus suppressed.

### Additional Remark 10

The illuminator according to any one of the additional remarks 1 to 9, further including
a third light source configured to output third light that belongs to a third wavelength band different from the first and second wavelength bands,
wherein the light combining member is configured to output the combined light that is a combination of the first light, the second light, and the third light.

The configuration described above can reduce speckle noise produced by the combined light containing the three types of color light.

### Additional Remark 11

The illuminator according to any one of the additional remarks 1 to 10, wherein
the first and second light sources are each a laser light source.

The configuration described above, in which using laser light as the illumination light causes optical interference to be likely to occur, can provide more remarkable advantages of the present disclosure resulting from reduction in the illuminance unevenness due to the optical interference.

### Additional Remark 12

A projector including:
the illuminator according to any one of the additional remarks 1 to 11;
a light modulator configured to modulate light output from the illuminator; and
a projection optical apparatus configured to project the light modulated by the light modulator,
wherein the first lens array surface is optically conjugate with an image generation region that generates an image in the light modulator.

The thus configured projector, in which the first lens array surface conjugate with a projection receiving surface is swung, can display a high-quality image with the illuminance unevenness and speckle noise suppressed without deterioration of the quality of the projected image.

What is claimed is:

1. An illuminator including:
a first light source configured to output first light that belongs to a first wavelength band;
a second light source configured to output second light that belongs to a second wavelength band different from the first wavelength band;
a light combining member configured to combine the first light and the second light with each other and output the combined light;
a light homogenizer having a first lens array surface on which the combined light is incident and a second lens array surface via which light traveling via the first lens array surface exits, the first lens array surface and the second lens array surface integrated with each other;
a swinging apparatus configured to swing the light homogenizer; and
a superimposing lens configured to superimpose luminous fluxes output from the light homogenizer on one another.

2. The illuminator according to claim 1, wherein
the swinging apparatus swings the first and second lens array surfaces as a unit along a direction perpendicular to an optical axis of the light homogenizer.

3. The illuminator according to claim 1, wherein
the swinging apparatus swings the first and second lens array surfaces as a unit along a first direction perpendicular to an optical axis of the light homogenizer and a second direction perpendicular to the optical axis and the first direction.

4. The illuminator according to claim 1, wherein
the first and second lens array surfaces are a single optical part formed as a unit, and
the swinging apparatus swings the optical part.

5. The illuminator according to claim 1, further comprising
a holding member configured to hold a first optical member having the first lens array surface and a second optical member having the second lens array surface as a unit, and fix a relative position of the first lens array surface with respect to the second lens array surface,
wherein the swinging apparatus swings the holding member.

6. The illuminator according to claim 1, further comprising
a polarization converter disposed between the light homogenizer and the superimposing lens and configured to align polarization directions of the light output from the light homogenizer with a predetermined polarization direction.

7. The illuminator according to claim 6, wherein
the swinging apparatus swings the polarization converter along with the light homogenizer.

8. The illuminator according to claim 1, further comprising:
a diffuser plate configured to diffuse the combined light incident from the light combining member; and
a collimator element configured to parallelize the combined light output from the diffuser plate.

9. The illuminator according to claim 1, wherein
a frequency of swinging motion generated by the swinging apparatus is higher than or equal to 60 Hz but lower than or equal to 500 Hz.

10. The illuminator according to claim 1, further comprising
a third light source configured to output third light that belongs to a third wavelength band different from the first and second wavelength bands,
wherein the light combining member is configured to output the combined light that is a combination of the first light, the second light, and the third light.

11. The illuminator according to claim 1, wherein
the first and second light sources are each a laser light source.

12. A projector comprising:
the illuminator according to claim 1;
a light modulator configured to modulate light output from the illuminator; and
a projection optical apparatus configured to project the light modulated by the light modulator,
wherein the first lens array surface is optically conjugate with an image generation region that generates an image in the light modulator.
